(19) United States
(12) Patent Application Publication
(10) Pub. No.: US 2008/0151202 A1
(43) Pub. Date: Jun. 26, 2008

(54) STAGE DEVICE AND EXPOSURE APPARATUS

(75) Inventor: Shinji Ohishi, Oyama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/952,016

(22) Filed: Dec. 6, 2007

(30) Foreign Application Priority Data
Dec. 21, 2006 (JP) 2006-344265

(51) Int. Cl. G03B 27/52; G03B 27/64

(52) U.S. Cl. 355/30; 355/76

(57) ABSTRACT

A stage device includes a stage configured to move along a base while holding a heating medium, and a heat exchange section configured to perform heat exchange of the heating medium. The heat exchange section includes an instruction unit configured to give instructions to move the stage to a heat exchange position, and a heat exchange unit configured to perform heat exchange of the heating medium at the heat exchange position.

### BACKGROUND OF THE INVENTION

1. Field of the Invention

The present invention relates to stage apparatuses, and more particularly, to a stage device that positions a substrate in an exposure apparatus.

2. Description of the Related Art

An exposure apparatus includes a stage device that positions a wafer (substrate). Japanese Patent Laid-Open No. 10-50588 discloses a stage device including a cooling mechanism that removes heat due to exposure light or heat due to a means for driving a stage.

FIG. 12 shows the cooling mechanism disclosed in the above publication. Referring to FIG. 12, a wafer 110 is fixed on a wafer holder 112, the wafer holder 112 is supported by a wafer table 114, and the wafer table 114 is fixed on a base 116.

Circulation paths 130 and 132 in which heating media circulate are respectively provided in the wafer holder 112 and the wafer table 114, and are respectively connected to temperature control units 134 and 136. Heating media temperature-controlled by the temperature control units 134 and 136 are supplied.

When an exposure operation starts, the wafer 110 absorbs energy of exposure light, and the temperature of the wafer 110 increases. While this heat of the wafer 110 is transmitted to the wafer table 114 via the wafer holder 112, it is released out by circulating the heating medium in the circulation path 130.

In order to circulate the heating medium in the moving members, such as the wafer holder 112 and the wafer table 114, as described above, the temperature control units 134 and 136 need to be always connected to the stage.

However, when the moving member (hereinafter referred to as a stage) moves, pipes for connecting the temperature control units 134 and 136 to the stage are dragged, and vibration of the pipes disturbs positioning of the stage.

Further, even while the stage is not moving, when liquid is used as the heating medium, a turbulent flow may occur and cause vibration of the pipes.

In addition, if the pipes are repeatedly bent while being dragged, tubes that form the pipes deteriorate, and the number of maintenance operations increases.

### SUMMARY OF THE INVENTION

The present invention provides a stage device that suppresses a decrease in stage positioning accuracy due to a cooling pipe.

A stage device according to an aspect of the present invention includes a base, a stage configured to move on the base while holding a heating medium, and a heat exchange unit configured to perform heat exchange of the heating medium when the stage is placed at a specific position on the base.

Further features and aspects of the present invention will become apparent from the following description of exemplary embodiments with reference to the attached drawings.

### BRIEF DESCRIPTION OF THE DRAWINGS

FIG. 1 is a side view of an example stage device according to a first exemplary embodiment of the present invention.

FIG. 2 is a plan view of the stage device.

FIG. 3 is a schematic view of a heat exchange section in the first exemplary embodiment.

FIGS. 4A and 4B are explanatory views of a heat exchange system in the first exemplary embodiment.

FIG. 5 is an explanatory view showing power feeding using electromagnetic induction.

FIG. 6 is an explanatory view showing signal transmission and receiving by using electromagnetic induction.

FIGS. 7A and 7B are schematic views of a heat exchange section in a second exemplary embodiment of the present invention.

FIG. 8 is a schematic view of the heat exchange section in the second exemplary embodiment.

FIG. 9 is a schematic view of a heat exchange section in a third exemplary embodiment of the present invention.

FIG. 10 is a flowchart showing a device manufacturing method.

FIG. 11 is a flowchart showing a wafer process.

FIG. 12 is a schematic view of a cooling mechanism disclosed in Japanese Patent Laid-Open No. 10-50588.

### DESCRIPTION OF THE EMBODIMENTS

### First Exemplary Embodiment

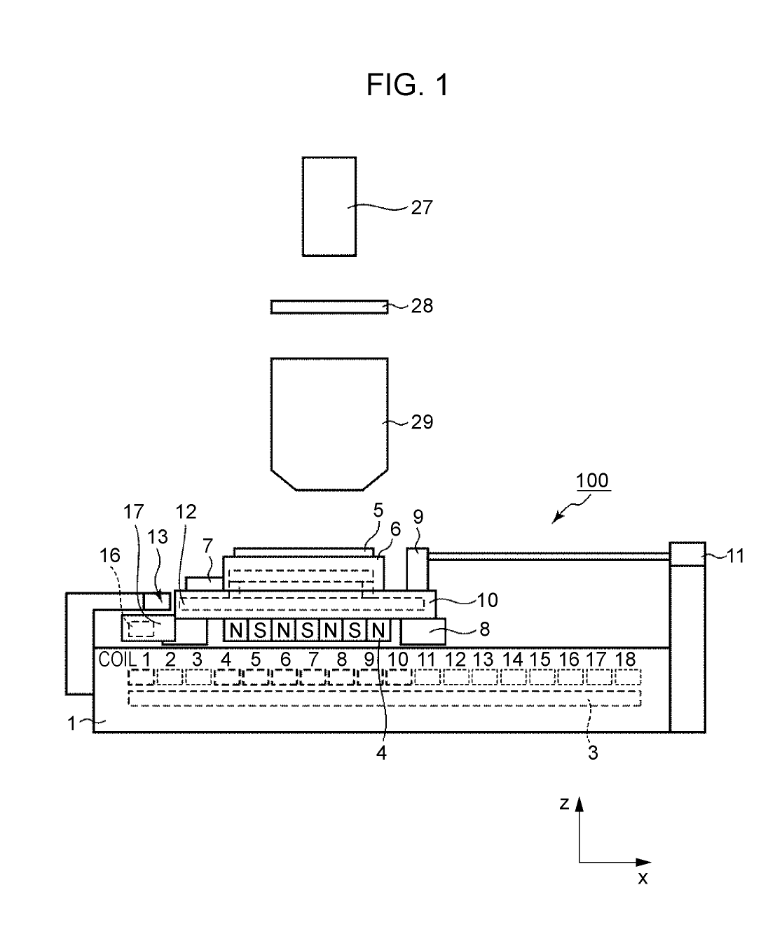

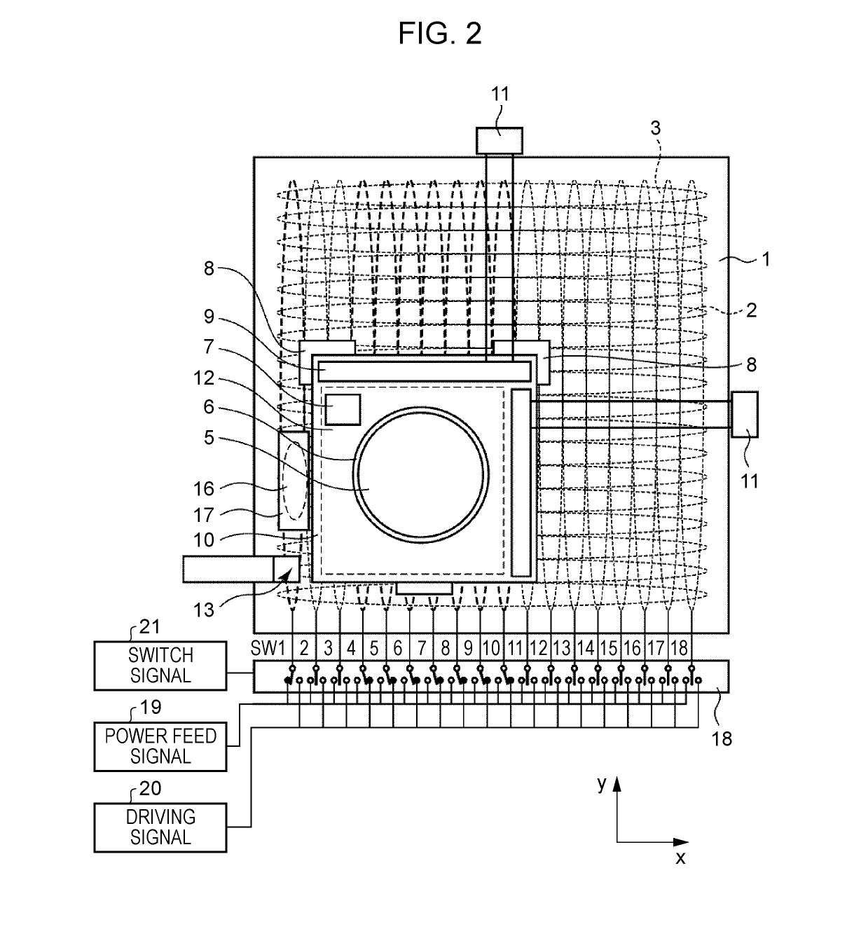

FIGS. 1 and 2 are a side view and a plan view, respectively, of a stage device according to a first exemplary embodiment of the present invention. In the first exemplary embodiment, a wafer stage that positions a wafer in an exposure apparatus will be described as an example.

Light guided from a light source 27 is applied onto a reticle (original) 28. On the reticle 28, a circuit pattern to be transferred onto a wafer 5 by exposure is formed of chromium or the like. After passing through the reticle 28, the light is narrowed and applied onto the wafer 5 by a projection optical system 29, so that the circuit pattern is projected onto the wafer 5 by exposure.

A stage device 100 includes a stage 10 on which the wafer 5 is mounted with an electrostatic chuck (holding unit) 6 disposed therebetween, a base 1 that supports the stage 10, a driving unit that drives the stage 10 relative to the base 1, and an interferometer 11 that measures the position of the stage 10.

A bearing 8 that supports the weight of the stage 10 is provided on a lower side of the stage 10. The stage 10 is guided two-dimensionally (in the X- and Y-directions) along a surface of the base 1.

The driving unit for driving the stage 10 includes a plurality of permanent magnets 4 arranged in a lattice form on the lower side of the stage 10, and a coil unit 2 provided in the base 1 and having a plurality of coils C1 to C18. The coils C1 to C18 in the coil unit 2 extend in the Y-direction, and are arranged in the X-direction. By feeding a current through coils facing the permanent magnets 4, of these coils C1 to C18, a Lorentz force is produced. The permanent magnets 4 are arranged so that the north poles and the south poles alternate two-dimensionally, and therefore, periodic magnetic flux passes through the coils. A coil unit 3 is provided below the coil unit 2, and includes a plurality of coils extending in the X-direction and arranged in the Y-direction. The stage 10 is driven in the X- and Y-directions by the above-described driving unit. The stage 10 may be driven in the X-, Y-, and Z-directions and be rotated about these directions.

A mirror 9 is provided on the stage 10. Laser light emitted from the interferometer 11 is reflected by the mirror 9. The position of the stage 10 is measured by using the reflected light. The stage 10 is controlled on the basis of the position measured by the interferometer 11 and a target position.

Sensors, such as a temperature sensor 7 for detecting the temperature of the stage 10, a light-quantity sensor for detecting the quantity of light emitted from the light source 27, and a sensor for aligning the wafer 5, are provided on the stage 10. The stage device 100 also includes a power supply unit that supplies power to the sensors and the electrostatic chuck 6. The power supply unit will be described below.

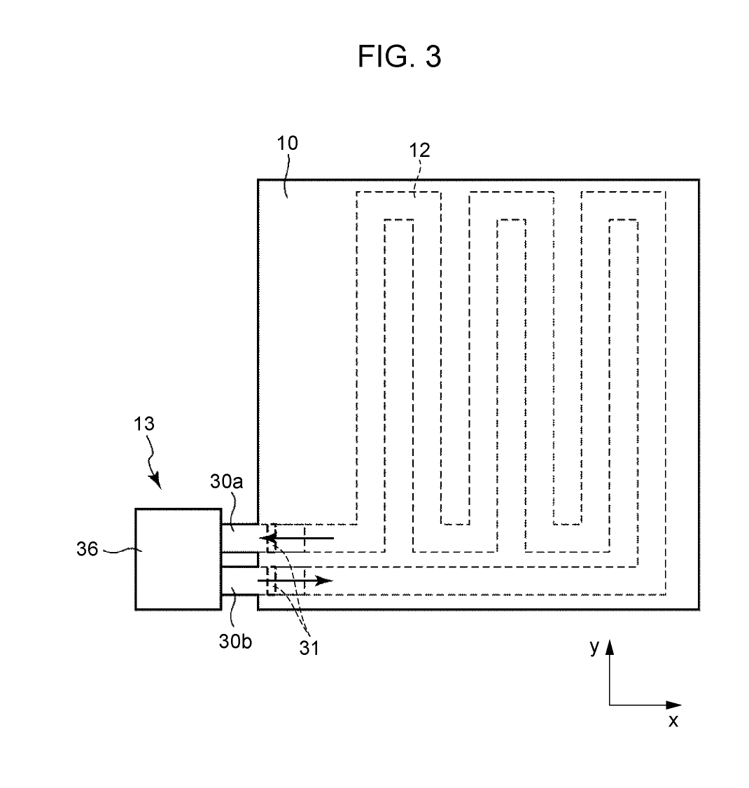

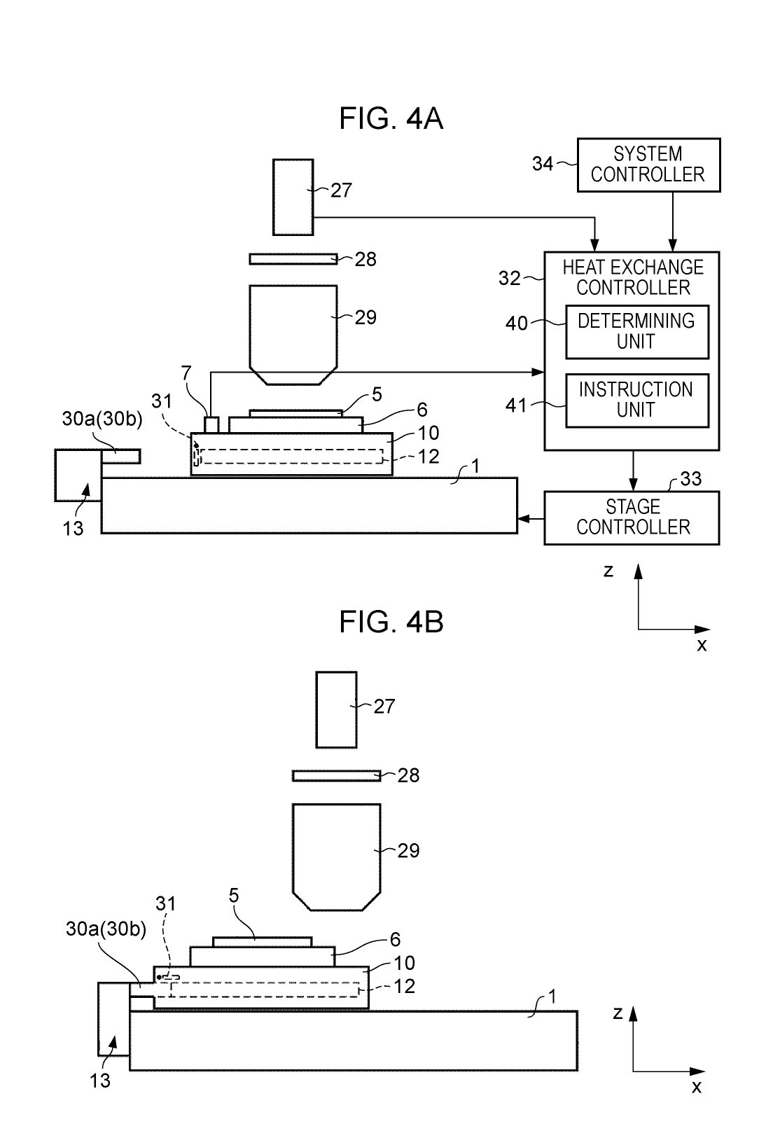

The stage 10 includes a heating-medium enclosure unit. The heating-medium enclosure unit includes a jacket 12 into and from which a heating medium can be supplied and recovered through openings, and sealing valves 31 (see FIGS. 3 and 4A-B) for closing the openings. It is satisfactory as long as the heating-medium enclosure unit is provided in a moving member that moves together with the stage 10, and the heating-medium enclosure unit can be provided in the wafer chuck 6. In FIG. 1, the heating-medium enclosure unit is provided in each of the stage 10 and the wafer chuck 6, and the heating-medium enclosure units are connected to each other.

When exposure starts, the temperature of the wafer 5 increases because the wafer 5 absorbs energy of exposure light. According to the first exemplary embodiment, thermal deflection of the stage 10 and the mirror 9 due to the heat from the wafer 5 can be suppressed by enclosing a heating medium having a large heat capacity in the jacket 12. For example, water or a fluorine liquid is preferably used as the heating medium. Since a change in the relative distance between the wafer 5 and the mirror 9 can be reduced by suppressing thermal deflection of the stage 10 and the mirror 9, measurement errors of the laser interferometer 11 can be reduced.

In the first exemplary embodiment, pipes through which the heating medium is supplied and recovered are not always connected to the stage 10. Therefore, the temperature of the heating medium in the jacket 12 is gradually increased by repetitions of exposure operation.

Accordingly, the stage device 100 includes a heat exchange section. The heat exchange section includes an instruction unit that gives instructions to move the stage 10 to a heat exchange position where the heating medium is replaced, and a heat exchange unit 13 that replaces the heating medium at the heat exchange position. That is, heat exchange starts after the stage 10 has moved to the heat exchange position.

FIG. 3 shows replacement of the heating medium by the heat exchange unit 13. The heat exchange unit 13 includes a recovery member 30a for recovering the heating medium, a supply member 30b for supplying the heating medium, and a temperature controller 36 for controlling the temperature of the heating medium to be supplied. For example, the recovery member 30a and the supply member 30b are formed by pipes capable of being connected to the openings of the jacket 12. In a state shown in FIG. 3, the pipes are connected to the openings of the jacket 12. The sealing valves 31 are opened when the heating medium is supplied and recovered.

With the above-described configuration, the heating medium with an increased temperature is recovered from the jacket 12, and a temperature-controlled heating medium can be sealed into the jacket 12.

FIGS. 4A and 4B are explanatory views of a heat exchange system in the first exemplary embodiment. The stage device 100 also includes a heat exchange controller 32. The heat exchange controller 32 includes a determining unit 40 that determines whether to replace the heating medium, and an instruction unit 41 that gives instructions to move the stage 10 to the heat exchange position on the basis of the determination result of the determining unit 40.

Next, a determination method with the determining unit 40 will be described below with reference to FIG. 4A. The determining unit 40 determines to perform heat exchange when the output from the temperature sensor 7 reaches a level that causes serious thermal deflection of the stage 10. In order to determine whether the output reaches the level, the output can be compared with a threshold level obtained beforehand by an experiment or a simulation and stored in a memory. On the basis of the determination result of the determining unit 40, the instruction unit 41 instructs a stage controller 33 to move the stage 10 to a heat exchange position (FIG. 4B) prestored in the memory.

In the first exemplary embodiment, the heat exchange position is not provided below the projection optical system 29. Therefore, the determining unit 40 determines that the heating medium is not replaced during exposure. For example, determination can be made according to a signal that is received from a system controller 34 and that indicates whether exposure is being performed.

While it is determined, on the basis of the output from the temperature sensor 7, whether to replace the heating medium in the above description, the determination may be made on the basis of any of the number of exposed wafers, the number of exposure shots on the wafer 5, and the dose. The determining unit 40 can obtain these values from the system controller 34. In this case, in order to determine whether thermal deflection reaches a serious level, the detected value can be compared with a threshold level obtained beforehand by an experiment or a simulation and stored in the memory.

After the heating medium is replaced, the stage 10 moves again for exposure and alignment sequences.

Since heat exchange of the heating medium provided in the stage 10 is performed after the stage 10 is moved to the specific heat exchange position, as described above, the heating medium is not always supplied and recovered. That is, the pipes through which the heating medium is supplied and recovered are not dragged by the movement of the stage 10. This can reduce the decrease in stage positioning accuracy. While it is preferable to provide the above-described determining unit that determines whether to perform heat exchange, a heat exchange process can be incorporated in the exposure sequence without making the determination.

By applying the above-described configuration to an EUV exposure apparatus, the degree of vacuum is prevented from being decreased by outgassing from the pipes.

Further, in the first exemplary embodiment, a power cable for supplying power to the various sensors and the electrostatic chuck 6 on the stage 10 is also not dragged. The power supply unit will be described below with reference to FIGS. 1 to 4.

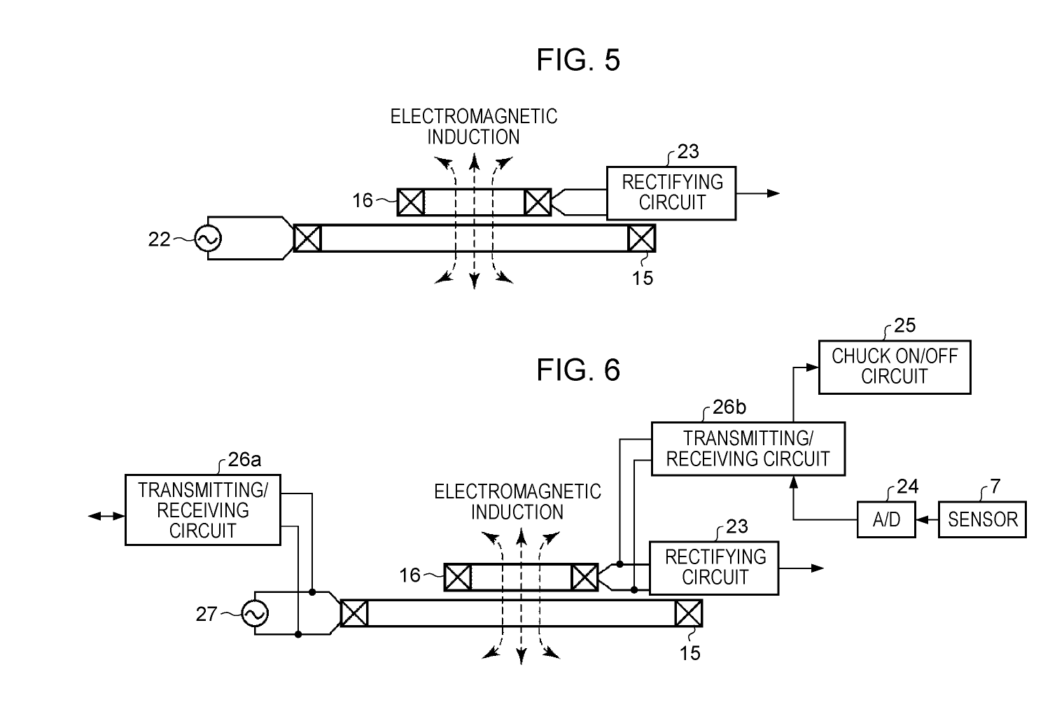

The power supply unit includes any of the coils in the coil unit 2 serving as a power transmission coil 15 (see FIGS. 5-6), and a coil supported on a side face of the stage 10 by a support member 17 so as to be a power receiving coil 16.

The power supply unit includes a switching unit 18 (see FIG. 2) that switches among a plurality of coils to which power is supplied, in accordance with the position of the stage 10. The switching unit 18 can switch between the coil for power supply and the coil for driving. More specifically, the switching unit 18 includes switches SW1 to SW18 connected to the coils C1 to C18. A power feed signal 19 and a stage driving signal 20 are connected to these switches SW1 to SW18. The switches SW1 to SW18 are controlled by a switch signal 21 corresponding to the position of the stage 10.

A description will now be given of a state in which the stage 10 is placed at the position shown in FIG. 1. Since the power receiving coil 16 faces the coil C1 in FIG. 1, the switch SW1 is connected to the power feed signal 19, and the coil C1 is used as the power transmission coil 15. Since the coils C4 to C10 face the permanent magnets 4, the switches SW4 to SW10 are connected to the driving signal 20, and the coils C4 to C10 are used as driving coils. Since the coils C2 and C3 do not face any of the power receiving coil 16 and the permanent magnets 4, the switches SW2 and SW3 are not connected to any signal and are kept open. The position of the stage 10 is measured with the laser interferometer 11. By controlling the switch signal 21 in accordance with the measured position, switching between the power transmission coil and the driving coils can be made properly.

FIG. 5 shows an example method for supplying power by using the power transmission coil 15 and the power receiving coil 16. Power is supplied by electromagnetic induction. When a current is fed through the power transmission coil 15, magnetic flux is produced in the directions of the arrows, and a current thereby flows through the power receiving coil 16. As the power feed signal 19, an alternating current 22 of several kilohertz to several tens of kilohertz is fed through the power transmission coil 15. In this way, power can be supplied to the electrostatic chuck 6 and the sensors. The power induced in the power receiving coil 16 is used after passing through a rectifying circuit 23.

Further, a control signal used for the electrostatic chuck 6 and the sensor 7 can be transmitted and received by electrostatic induction. In this case, it is possible to adopt a structure in which a wire for transmitting and receiving the control signal is not dragged. This structure will be described with reference to FIG. 6.

A transmitting/receiving circuit 26a is provided at an end of the power transmission coil 15, and a transmitting/receiving circuit 26b is provided at an end of the power receiving coil 16. The transmitting/receiving circuit 26a at the power transmission coil 15 is connected to, for example, a main controller of the exposure apparatus. The transmitting/receiving circuit 26b at the power receiving coil 16 is connected to, for example, an ON/OFF circuit 25 of the electrostatic chuck 6 and an A/D converter 24 that converts analog signals from the sensors into digital signals.

By superimposing and transmitting the control signal to the coil that supplies power, the control signal can be transmitted and received by electrostatic induction. Since a current of several kilohertz to several tens of kilohertz is used as the power feed alternating current 22, there is a need to use a high-frequency signal of several hundreds of kilohertz to several megahertz that does not interfere with the power feed current in terms of frequency.

### Second Exemplary Embodiment

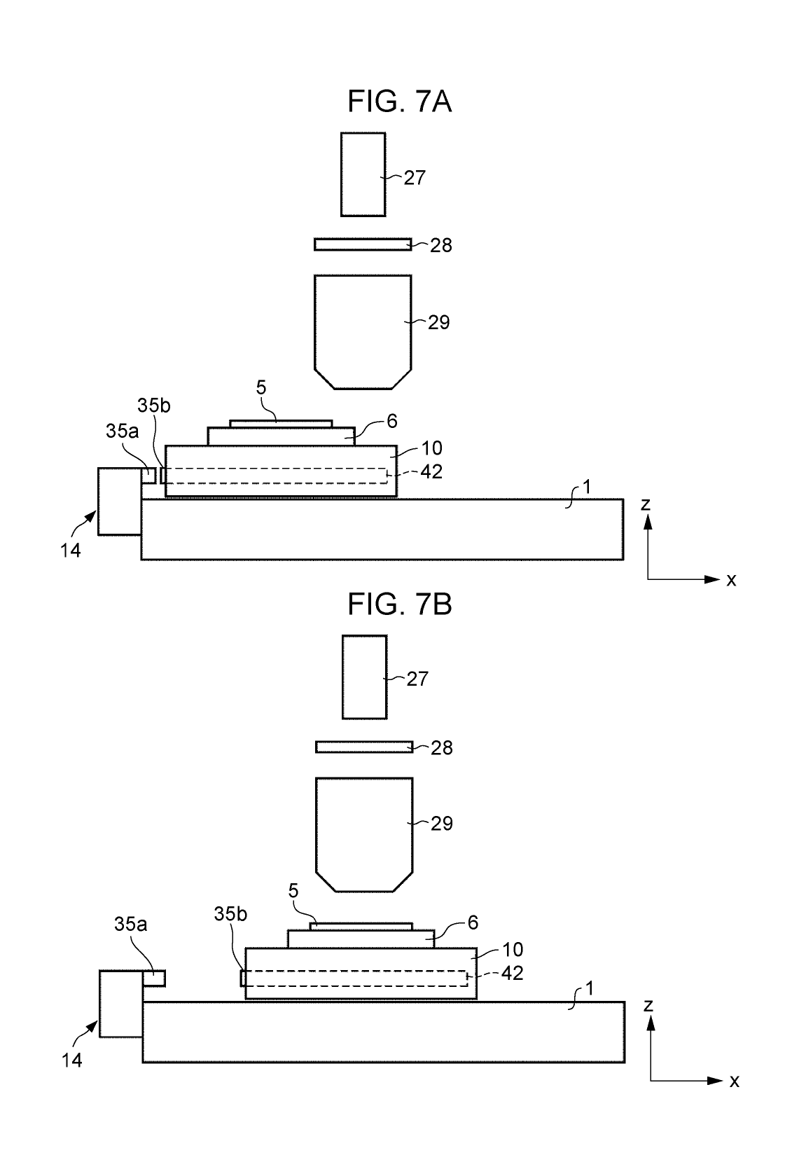

A stage device according to a second exemplary embodiment will be described with reference to FIGS. 7A and 7B. While the heating medium is replaced in the first exemplary embodiment, heat energy of the heating medium is exchanged by radiation. Components that are not specified in the second exemplary embodiment are similar to those in the first exemplary embodiment.

In the second exemplary embodiment, a stage device 100 includes a mechanism provided in a stage 10 so as to hold a heating medium 42, and a radiation plate 35b provided on the stage 10 so as to radiate heat of the heating medium 42 to the outside. When the heating medium 42 is liquid, the mechanism for holding the heating medium 42 can be formed by a heating-medium enclosure unit similar to that adopted in the first exemplary embodiment. When the heating medium 42 is solid, the mechanism can be fastened in contact with the stage 10 so that heat of a wafer 5 is transmitted to the heating medium 42. In this case, the heating medium 42 is formed of, for example, chromium, zirconium, carbon, tungsten, tantalum, niobium, iron, copper, titanium, nickel, molybdenum, or an alloy of these materials.

The stage device 100 also includes a heat exchange section. The heat exchange section includes an instruction unit that gives instructions to move the stage 10 to a heat exchange position where heat exchange of the heating medium 42 is performed, and a heat exchange unit 14 that exchanges heat energy of the heating medium 42 at the heat exchange position.

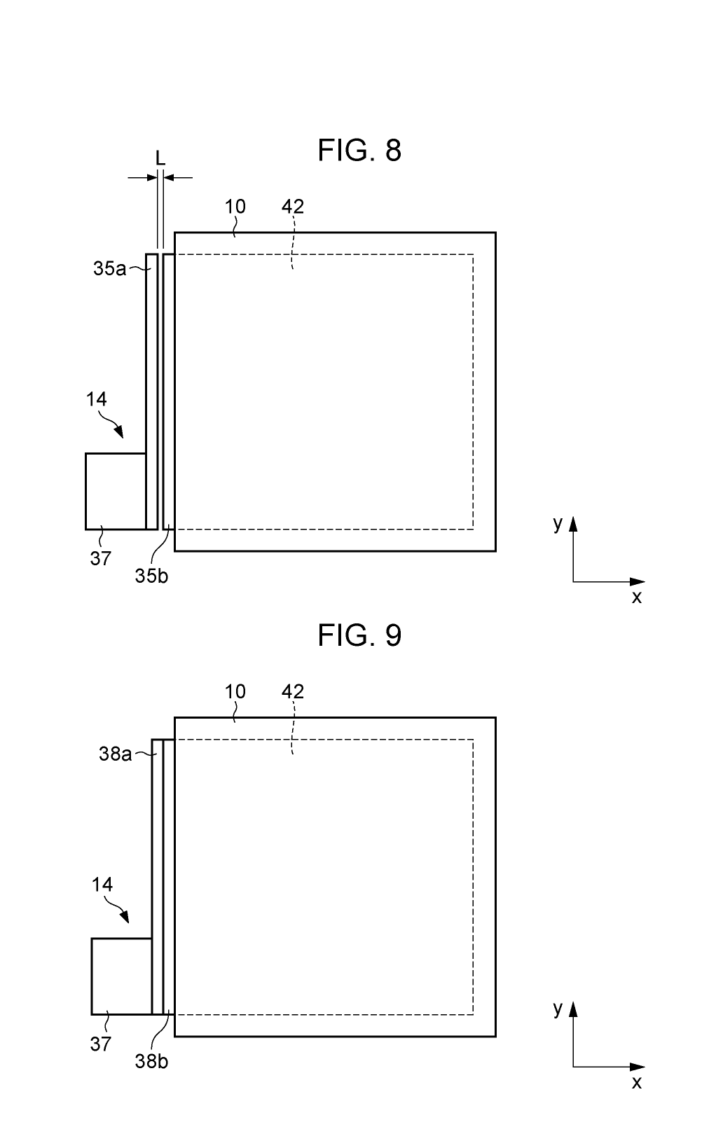

The heat exchange unit 14 includes a radiation plate 35a provided at the heat exchange position, and a temperature controller 37 (see FIG. 8) provided on the radiation plate 35a so as to control the temperature of the radiation plate 35a. The temperature controller 37 includes a channel provided, for example, in the radiation plate 35a or a member for supporting the radiation plate 35a, and a mechanism that circulates a temperature-controlled refrigerant through the channel. In order to quickly control the temperature of the radiation plate 35a, a Peltier element may be added.

FIGS. 7A and 7B show a heat exchange operation performed in the second exemplary embodiment, and FIG. 8 is a plan view of the heat exchange section shown in FIG. 7A.

While the stage 10 is placed at the heat exchange position, the radiation plate 35a and the radiation plate 35b face each other with a small gap L between. In this case, heat energy is exchanged between the radiation plates 35a and 35b by radiation. For example, by lowering the temperature of the radiation plate 35a, heat stored in the heating medium 42 by exposure light is transmitted to the radiation plate 35a via the radiation plate 35b. The radiation plates 35a and 35b are preferably formed of copper or silver.

According to the second exemplary embodiment, since heat energy can be exchanged in a noncontact manner by radiation, a clean environment can be achieved with little refuse. Further, since the heating medium is not supplied and recovered, unlike the first exemplary embodiment, it will not spill during heat exchange.

### Third Exemplary Embodiment

A stage device according to a third exemplary embodiment will be described with reference to FIG. 9. While heat exchange is performed by radiation in the second exemplary embodiment, it is performed by heat conduction between the components in the third exemplary embodiment. Components that are not specified in the third exemplary embodiment are similar to those in the second exemplary embodiment.

FIG. 9 is a plan view showing exchange of heat energy. In the third exemplary embodiment, a stage device 100 includes a mechanism that holds a heating medium 42, and a heat transmitting portion 38b that releases heat of the heating medium 42 to the outside by heat conduction.

The stage device 100 also includes a heat exchange section. The heat exchange section includes an instruction unit that gives instructions to move a stage 10 to a heat exchange position where heat exchange of the heating medium 42 is performed, and a heat exchange unit 14 that exchanges heat energy of the heating medium 42 at the heat exchange position.

The heat exchange unit 14 includes a heat conducting portion 38a provided at the heat exchange position, and a temperature controller 37 provided on the heat conducting portion 38a so as to control the temperature of the heat conducting portion 38a. The temperature controller 37 includes a channel provided, for example, in the heat conducting portion 38a or a member for supporting the heat conducting portion 38a, and a mechanism that circulates a temperature-controlled refrigerant through the channel. In order to quickly control the temperature of the heat conducting portion 38a, a Peltier element may be added.

While the stage 10 is placed at the heat exchange position, the heat conducting portion 38a and the heat conducting portion 38b are in contact with each other. In this case, heat energy is exchanged between the heat conducting portions 38a and 38b by heat conduction. For example, by lowering the temperature of the heat conducting portion 38a, heat stored in the heating medium 42 by exposure light is transmitted to the heat conducting portion 38a via the heat conducting portion 38b.

According to the third exemplary embodiment, since heat energy can be exchanged in a noncontact manner by heat conduction, a clean environment can be achieved with little refuse. Further, since the heating medium is not supplied and recovered, unlike the first exemplary embodiment, it will not spill during heat exchange. In addition, heat exchange of the heating medium can be performed by heat conduction in a period shorter than by radiation.

### Exemplary Embodiment of Device Manufacturing Method

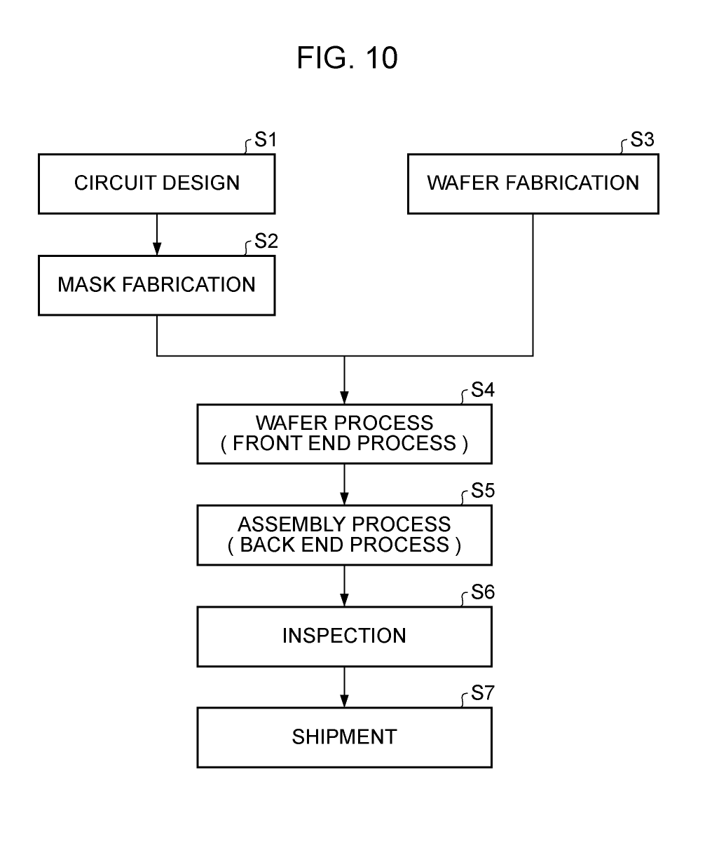

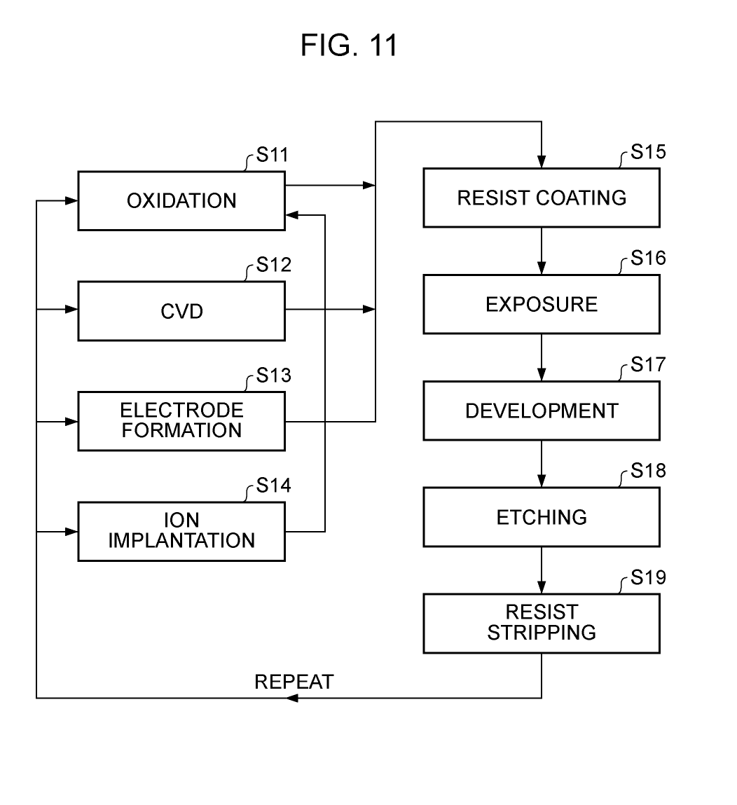

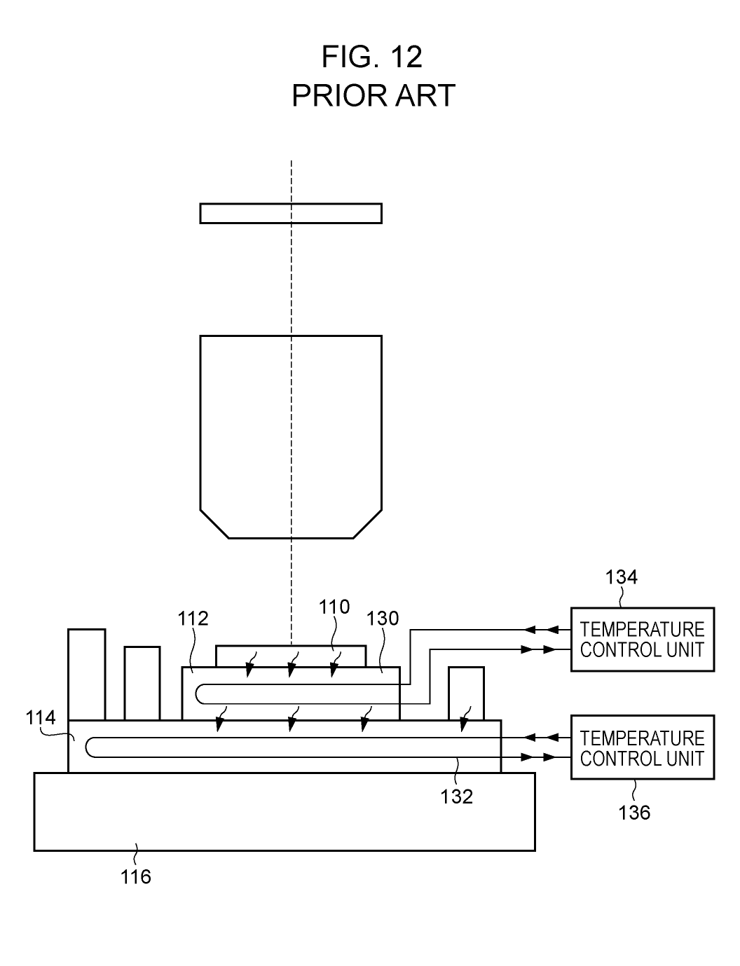

Referring to FIGS. 10 and 11, a description will be given of an exemplary embodiment of a device manufacturing method using the above-described exposure apparatus. FIG. 10 is a flowchart showing a manufacturing procedure for devices (e.g., semiconductor chips such as ICs and LSIs, LCDs, and CCDs). Herein, a manufacturing method for a semiconductor chip will be described as an example.

In Step S1 (circuit design), a circuit pattern of a semiconductor device is designed. In Step S2 (mask fabrication), a mask having the designed circuit pattern is fabricated. In Step S3 (wafer fabrication), a wafer is made of, for example, silicon. In Step S4 (wafer process) called a front end process, an actual circuit is formed on the wafer by using the mask and the wafer by lithography in the exposure apparatus. In Step S5 (assembly) called a back end process, a semiconductor chip is produced by using the wafer fabricated in Step S4. The back end process includes, for example, an assembly step (dicing, bonding) and a packaging step (chip encapsulation). In Step S6 (inspection), the semiconductor device produced in Step S5 is subjected to various inspections such as an operation confirmation test and a durability test. A semiconductor device is completed through the above steps, and is then shipped (Step S7).

FIG. 11 is a detailed flowchart of the above-described wafer process (Step 4). In Step S11 (oxidation), the surface of the wafer is oxidized. In Step S12 (CVD), an insulating film is formed on the surface of the wafer. In Step S13 (electrode formation), electrodes are formed on the wafer by vapor deposition. In Step S14 (ion implantation), ions are implanted into the wafer. In Step S15 (resist coating), a photosensitive material is applied on the wafer. In Step S16 (exposure), the wafer is exposed via the circuit pattern of the mask by the exposure apparatus. In Step S17 (development), the exposed wafer is developed. In Step S18 (etching), a portion other than the developed resist image is removed. In Step S19 (resist stripping), the resist, which has become unnecessary after etching, is removed. By repeating these steps, multiple circuit patterns are formed on the wafer.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-344265 filed Dec. 21, 2006, which is hereby incorporated by reference herein in its entirety.

What is claimed is:

1. A stage device comprising:
a base;
a stage configured to move on the base while holding a heating medium; and
a heat exchange unit configured to perform heat exchange of the heating medium when the stage is placed at a specific position on the base.

2. The stage device according to claim 1, further comprising:
an instruction unit which gives instructions to move the stage to the heat exchange position,
wherein the heat exchange unit starts heat exchange after the stage moves to the specific position.

3. The stage device according to claim 1,
wherein the stage includes a jacket in which the heating medium is enclosed; and
wherein the heat exchange unit includes a supply unit configured to supply the heating medium into the jacket and a recovery unit configured to recover the heating medium from the jacket.

4. The stage device according to claim 1, wherein the heat exchange unit performs heat exchange of the heating medium by radiation or heat conduction.

5. The stage device according to claim 1, further comprising:
a temperature sensor configured to measure the temperature of the stage; and
a determining unit configured to determine, on the basis of an output from the temperature sensor, whether to perform heat exchange by the heat exchange unit.

6. A stage device comprising:
a base;
a stage movable on the base, the stage including a jacket in which a heating medium is enclosed; and
a pipe configured to be connected to and disconnected from the jacket when the stage is placed at a specific position on the base,
wherein the heating medium in the jacket is replaced via the pipe.

7. A stage device comprising:
a base;
a stage configured to move on the base while holding a heating medium;
a radiation plate facing the heating medium in a noncontact manner when the stage is placed at a specific position on the base; and
a temperature controller configured to control the temperature of the radiation plate.

8. A stage device comprising:
a base;
a stage configured to move on the base while holding a heating medium;
a heat conducting portion provided in contact with the heating medium when the stage is placed at a specific position on the base; and
a temperature controller configured to control the temperature of the heat conducting portion.

9. An exposure apparatus comprising:
a stage device including,
a base;
a stage configured to move on the base while holding a heating medium; and
a heat exchange unit configured to perform heat exchange of the heating medium when the stage is placed at a specific position on the base,
wherein the exposure apparatus is configured to position a substrate or original using the stage device.

10. The exposure apparatus according to claim 9, further comprising:
a determining unit configured to determine whether to perform heat exchange by the heat exchange unit, on the basis of any of the number of exposed substrates, the number of exposure shots on the substrates, and the dose.

11. The exposure apparatus according to claim 9, wherein the stage is disposed in a chamber in which a vacuum atmosphere is provided.
